(19) United States
(12) Patent Application Publication
(10) Pub. No.: US 2006/0272186 A1
(43) Pub. Date: Dec. 7, 2006

(54) Display system

(76) Inventor: Frederic Jean-Pierre Demole, London (GB)

Correspondence Address: NIXON & VANDERHYE, PC, 901 NORTH GLEBE ROAD, 11TH FLOOR, ARLINGTON, VA, 22203, US

(21) Appl. No.: 10/556,080

(22) PCT Filed: May 10, 2004
(86) PCT No.: PCT/EP04/05002

§ 371 Date: Dec. 8, 2005

(30) Foreign Application Priority Data
May 10, 2003 (GB) 0310776.0
Apr. 21, 2004 (GB) 0408855.5

(51) Int. Cl. G09F 11/30

(52) U.S. Cl. 40/508

(57) ABSTRACT

A system for displaying alphanumeric characters in airports, train stations or cinemas. The system comprises a small robot (1) on a rail (2) that can move along a stack of cards (3) on which alphanumerical characters are printed. The robot (1) is able to pick-up any card, place it on a mobile holding means (4). By repeating this operation words, numbers or codes can be formed. The holding means (4) is mobile in order to be in such a position as to exchange cards or in a position to display the composed information. The system provides for simplified pick-up, placing and retrieving operation and does not expose the hardware of the system to the public.

In WO 84-02791 A1 there is disclosed a system comprising means for picking up a card on which an alphanumeric character is printed and placing it in such a position along with other cards similarly picked-up and placed onto a holding means, forming a word or a number that is displayed and visible to the public. In order to display another word or number the cards are first retrieved from their displaying position and replaced in the stack of cards.

Such a system could find applications in locations such as airports, train stations and cinemas.

One drawback of such a system is that the system is complicated due to the fact that the pick-up system needs to do the complex task of picking-up the card from a stack of cards and place it alongside others in a display position, as well as doing the inverse complex task to retrieve it from a display position and replace it in the stack of cards. Another drawback of the system is that the system exposes to the public a rather inesthetic view of the hardware picking-up and placing or retrieving the cards for a significant amount of time during which no useful information is being displayed.

The present invention is characterised in that a display system comprises a card handling means (1) able to move on a rail (2), that can pick-up any card out of a stack of cards (3) on which alphanumerical characters are printed and place it on a structure holding the cards (holding means) (4). By repeating this process, words and numbers are composed. In order to display another word or number the cards are first retrieved from the holding means (4)and replaced in the stack of cards (3).

In most embodiments of the present inventions the holding means (4) holding the cards is mobile in order to simplify the task of the card handling means (1) as well as to hide the mechanics of the system from the public and to provide for a minimal time between the display of the previously displayed information to the display of the information to be displayed next.

An electronic system may control the movement of the card handling means as well as the movement of the holding means (4).

Following is a description, by way of example only and with reference to the accompanying drawings, of one method of carrying the invention into effect.

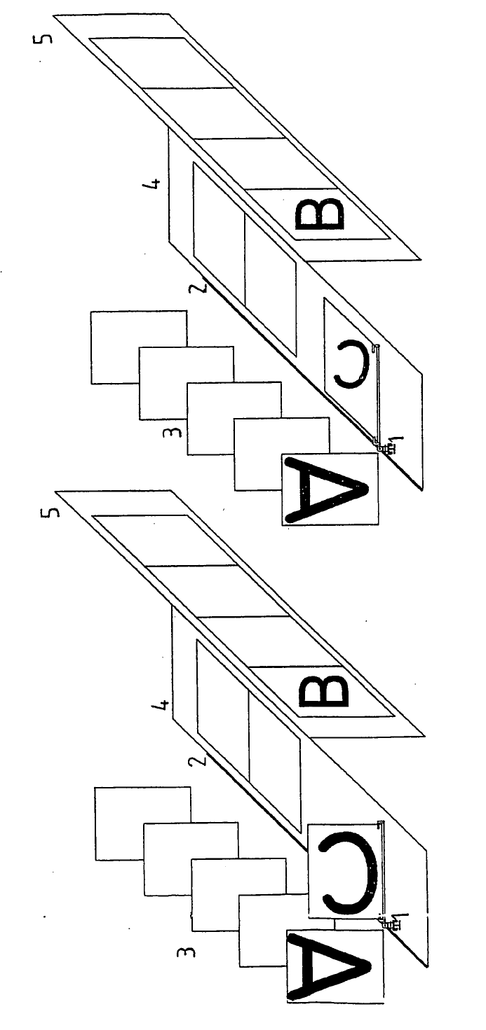

Referring now to FIG. 1 of the drawings, there is shown a preferred embodiment of a display system where one holding means (4) lies horizontally close to the rail(2) on which the card handling means (1) moves. The other holding means (5) is in a display position on the front side of the system, visible to the public. A card handling means(l) runs along a rail (2) between the stack of cards (1) and the horizontally laid holding means (4) and retrieve cards from the holding means (4), picks up new cards and place them on the holding means (4), composing the new information to be displayed.

Once the new information has been composed, both holding means (4,5) are moved; the one that was in a horizontal position (4) for placing or retrieving cards goes to a vertical display position (5), the one that was in a vertical display position (5) moves to the horizontal position (4).

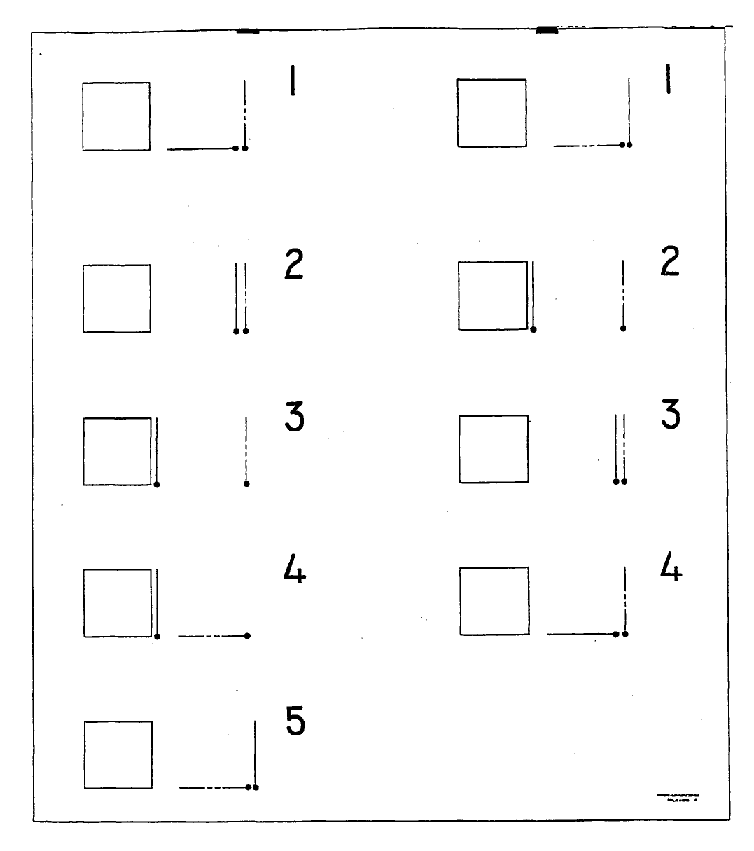

Referring now to FIG. 2 of the drawings, there is shown in a very simple way the sequence of movement of each mobile holding means. The system is viewed from one of its lateral side. One of the holding means drawn in full lines is mounted on-a rotation axis along its bottom side and can also move on a set of rails between a display position and a position close to the stack of cards. The other holding means drawn in partially dotted lines is mounted on a rotation axis along its bottom side such that it can be moved between a vertical display position and an horizontal position in order to place or retrieve cards.

On the left hand side of the figure, numbers one to five describe the sequence of movements to go from the holding means in full lines in an horizontal position and the holding means in dotted lines in vertical position to the holding means in dotted lines in an horizontal position and the holding means in full lines in a vertical position.

On the right hand side of the figure, numbers one to four describe the sequence of movements to go from the holding means in dotted lines in an horizontal position and the holding means in full lines in a vertical position to the holding means in full lines in an horizontal position and the holding means in dotted lines in a vertical position.

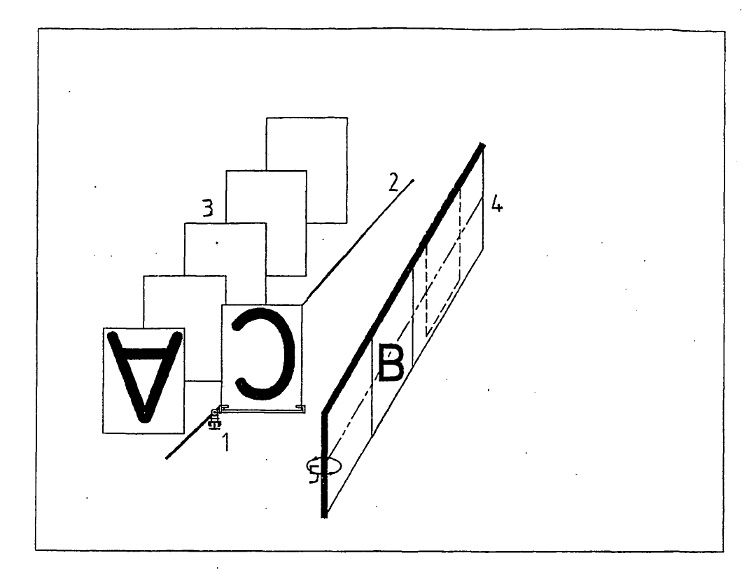

Referring now to FIG. 3 of the drawings, there is shown an embodiment of a display system where the holding means (4) is able to rotate along its longitudinal axis (5) so as to display either of its two faces. One face is in display position, the other face is not in a display position and is available for the card handling means (1) to retrieve cards from it or to place new cards on it. The card handling means (1) runs along a rail (2) between the stack of cards (3) and the holding means (4) and retrieve cards from the previously displayed information, picks up new cards and place new cards on that side of the holding means (4) that is not visible to the public and composes the information to be displayed after the previously displayed information. Once the new information has been composed, the holding means (4) is rotated along its longitudinal axis (5) so as to display the newly composed information.

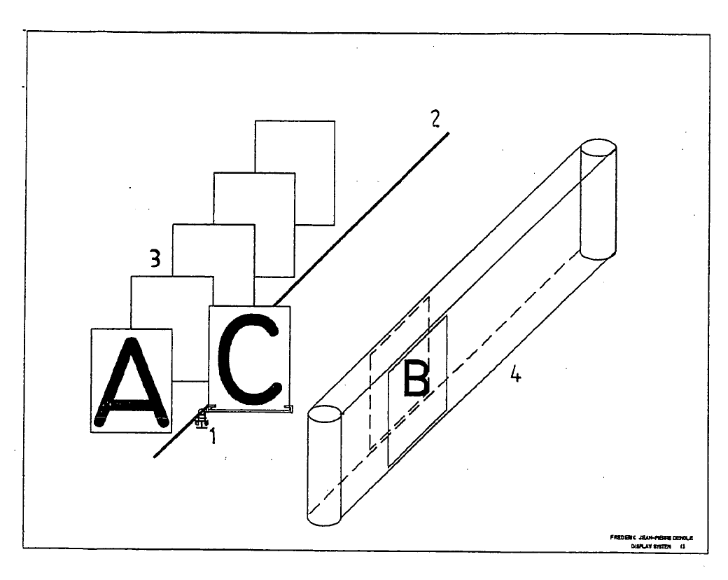

Referring now to FIG. 4 of the drawings, there is shown an embodiment of a display system where the holding means (4) is articulated or flexible and its two ends are attached to each other forming a loop and can be moved so as to display either of its two parts. One part is in display position, the other part is not in a display position and is available for the card handling means (1) to retrieve cards from it or to place new cards on it. The card handling means (1) runs along a rail (2) between the stack of cards (3) and the holding means (4) and retrieve cards from the previously displayed information, places them back in the stack of cards, picks up new cards, place them on that part of the holding means (4) that is not in a display position and so composes the new information to be displayed. Once the new information has been composed, the holding means (4) is moved so as to display the newly composed information.

Another embodiment of a display system comprises a stack of cards, a card handling means able to retrieve cards from a holding means and put them back into the stack of cards, pick-up new cards and place them on the holding means. The system also comprises a mobile shade that is about the same size as the holding means and that can be moved and that can be placed either in front of the holding means in order to hide the holding means from the view of the public while cards are being exchanged or can be moved away from the holding means, exposing the holding means to the view of the public, and stored.

Another embodiment of a display system comprises a stack of cards, a card handling means to retrieve cards from or place new cards on a holding means, a stack of holding means, each holding means lying one above the other in order to form a column of holding means. The card handling means can retrieve cards from or place new cards on a holding means. After the cards have been placed on the holding means, that holding means is placed just below the column of holding means, providing a new line of information. If necessary, the column of holding means can be moved one holding means height up. If necessary, the holding means on top of the column can be removed and made available below for the card handling means.

Another embodiment of a display system comprises a stack of cards, a card handling means to place or retrieve the cards on a holding means, a stack of holding means, where each holding means is attached by its upper side to the one above it and by its lower side to the one below it, effectively forming a closed loop of holding means. Only a number of the holding means forming the loop are visible to the public. The card handling means can place or retrieve cards on or from a holding means. After the cards have been placed on that holding means, the whole loop of holding means is moved so that that holding means that entail new information becomes visible to the public, while a number of the holding means that were previously visible continue to remain visible. It may be that one holding means that was on top of that part of the loop of holding means that was visible to public is not visible anymore.

The last two arrangements are particularly appropriate for train stations for example where a number of train data should be displayed as a list of trains departing with the earliest trains on top and the next trains below in chronological order. When one train leaves, the closed loop of holding means moves, hiding the departed train data and exposing the train data from the train at the bottom of the list.

The term information in this document includes any alphanumerical character, any letter or number or any sign or shade or color or cavity or any hole or elevation of the surface of the card or any physical or electromagnetic ray or light coming through or from the card or any combination thereof.

1. A display system comprising a number of cards (3), some cards provided with information, a number of holding means (4,5) able to hold the cards, and comprising card handling means (1) able to retrieve that card from a holding means (4) or pick a particular card from the cards (3) and to place a card on a holding means (4) so as to compose a new information made from a number of cards to be displayed, characterised in that the holding means (4,5) can be moved by moving means between a position (4) appropriate for the placing and retrieving system (1) to place or retrieve cards from the holding means (4), and another position (5) appropriate for displaying the composed information.

2. A display system comprising a number of cards (3), some cards provided with information, a holding means (4) able to hold the cards, and comprising card handling means (1) able to retrieve a card from a holding means (4) or pick a particular card from the cards (3) and to place that card on a holding means (4) so as to compose a new information made from a number of cards to be displayed, characterised in that the holding means (4) can be moved by moving means along its longitudinal axis (5) in order to present one of its face for displaying the composed information and to present its other face to the placing and retrieving system (1) so that the placing and retrieving system (1) is able to place or retrieve cards from the other face of the holding means (4).

3. A display system comprising a number of cards (3), some cards provided with information, a holding means (4) able to hold the cards, and comprising card handling means (1) able to retrieve a card from a holding means (4) or pick a particular card from the cards (3) and to place that card on a holding means (4) so as to compose a new information made from a number of cards to be displayed, characterised in that the holding means' (4) ends are attached to each other and that the holding means (4) forms a loop and that the holding means (4) can be moved by moving means in order to present one of its part for displaying the composed information and to present its other part to the placing and retrieving system (1) so that the placing and retrieving system (1) is able to place or retrieve cards from that other part of the holding means (4).

4. A display system comprising a number of cards, some cards provided with information, a holding means able to hold the cards, and comprising card handling means able to retrieve a card from a holding means (4) or pick a particular card from the cards (3) and to place that card on a holding means (4) so as to compose a new information made from a number of cards to be displayed, characterised in that there is provided a shade that can be moved by moving means and lies either in front of the holding means so that the holding means are not visible to the public in order to hide it while cards are being exchanged or lies in a stored position away from the holding means.

5. A display system comprising a number of cards, some cards provided with information, a number of holding means able to hold the cards, lying above each other, and comprising card handling means able to retrieve a card from a holding means (4) or pick a particular card from the cards (3) and to place that card on a holding means (4) so as to compose a new information made from a number of cards to be displayed, characterised in that that holding means holding the newly composed information is placed in a display position below the number of holding means.

6. A display system comprising a number of cards, some cards provided with information, a number of holding means, each able to hold cards, and comprising card handling means able to retrieve a card from a holding means or pick a particular card from the cards and to place that card on a holding means so as to compose a new information made from a number of cards to be displayed, characterised in that the holding means are attached to each other, forming a loop of holding means, and after a newly composed information has been placed on a particular holding means, the number of holding means can be moved by moving means, so that after the number of holding means has been moved one of the holding means that was previously not in a display position is now in a display position, while a number of the holding means that were previously in a display position remain in a display position.

7. A display system as claimed in claim 1 where an electronic system directs the movements of the card handling means (1) or the movements of the holding means (4,5).

8. A display system as claimed in claim 1 where there are provided securing means to secure a card on a holding means (4,5) so that the card remains in place.
